(19) United States
(12) Patent Application Publication
(10) Pub. No.: US 2024/0116043 A1
(43) Pub. Date: Apr. 11, 2024

(54) HIGHLY DISPERSED METAL SUPPORTED OXIDE AS NH3-SCR CATALYST AND SYNTHESIS PROCESSES

(71) Applicants: TOYOTA MOTOR EUROPE, Brussels (BE); CENTRE NATIONAL DE LA RECHERCHE SCIENTIFIQUE, Paris (FR); UNIVERSITE CLAUDE BERNARD LYON 1, Villeurbanne (FR); ECOLE SUPERIEURE DE CHIMIE PHYSIQUE ELECTRONIQUE DE LYON, Villeurbanne (FR)

(72) Inventors: Phuc Hai NGUYEN, Brussels (BE); Nicolas MERLE, Marcq-en-Baroeul (FR); Marc-Olivier CHARLIN, Sainte-Sigolene (FR); Kai Chung SZETO, Villeurbanne (FR); Mostafa TAOUFIK, Villeurbanne (FR)

(73) Assignees: TOYOTA MOTOR EUROPE, Brussels (BE); CENTRE NATIONAL DE LA RECHERCHE SCIENTIFIQUE, Paris (FR); UNIVERSITE CLAUDE BERNARD LYON 1, Villeurbanne (FR); ECOLE SUPERIEURE DE CHIMIE PHYSIQUE ELECTRONIQUE DE LYON, Villeurbanne (FR)

(21) Appl. No.: 18/523,231

(22) Filed: Nov. 29, 2023

Related U.S. Application Data
(62) Division of application No. 17/616,942, filed on Dec. 6, 2021.

(51) Int. Cl. B01J 37/02; B01D 53/94; B01J 21/06; B01J 23/10; B01J 23/20; B01J 23/22; B01J 23/28; B01J 23/30; B01J 23/72; B01J 31/02; B01J 31/16; B01J 31/22; B01J 37/08

(52) U.S. Cl. CPC B01J 37/0207; B01D 53/9418; B01J 21/066; B01J 23/10; B01J 23/20; B01J 23/22; B01J 23/28; B01J 23/30; B01J 23/72; B01J 31/0212; B01J 31/1625; B01J 31/2265; B01J 31/2295; B01J 37/0203; B01J 37/0209; B01J 37/086; B01D 2255/20723; B01D 2255/20761; B01D 2255/20769; B01D 2255/20776; B01J 2531/16; B01J 2531/57; B01J 2531/58; B01J 2531/64; B01J 2531/66

(57) ABSTRACT

A process for preparing a catalyst material, includes: (a) providing a support material having surface hydroxyl (OH) groups, the support material is ceria (CeO₂), zirconia (ZrO₂) or a combination, and the support material contains between 0.3 and 2.0 mmol OH groups/g of the support material; (b) reacting the support material with at least one of: (b1) a compound containing at least one alkoxy or phenoxy group bound though its oxygen atom to a metal element from Group 5 (V, Nb, Ta) or Group 6 (Cr, Mo, W); (b2) a compound containing at least one hydrocarbon group bound though a carbon atom to a metal element from Group 5 or 6; (b3) a compound containing at least one hydrocarbon group bound though a carbon atom to a metal element which is copper (Cu); and (c) calcining the product obtained in step (b).

### FIELD OF THE INVENTION

The present invention relates to the synthesis of ammonia selective catalytic reduction (NH₃-SCR) catalysts for nitrogen oxides (NOx) reduction.

### BACKGROUND ART

Toxic NOx gases (NO, NO₂, N₂O) included in exhaust gases from fossil-fuel-powered vehicles or stationary sources such as power plants are required to be converted to N₂ before being released to the environment. This is normally done by using different types of NOx reduction catalysts such as three-way catalysts (TWC), NOx storage reduction (NSR), or selective catalytic reduction (SCR) using ammonia as external reducing agent (NH₃-SCR).

Metal oxides such as V₂O₅ are known to be good NH₃-SCR catalysts. It has been suggested that the catalytic activity is achieved by the complementary features of acidity and reducibility of the surface species. Briefly, NH₃ is adsorbed on a Brønsted acid site (V⁵⁺—OH) followed by N—H activation through the adjacent V═O surface groups through a redox cycle (V⁵=O/V⁴⁺—OH). The resulting surface complex reacts with gaseous or weakly adsorbed NO through Langmuir-Hinshelwood and Eley-Rideal mechanisms, respectively, to form NH₂ NO intermediate species which undergo decomposition into N₂ and H₂O. An alternate mechanism (amide-nitrosamide) involving the adsorption of NH₃ over Lewis acid sites has also been proposed. Furthermore, under realistic conditions, particularly when a peroxidation catalytic convertor is placed upstream of the SCR catalytic convertor, this gives rise to formation of nitrogen dioxide which favors the SCR reaction known as fast-SCR. Indeed NO₂ allows fast re-oxidation of the reduced species. However, the optimal NO₂/NO ratio is one, and the presence of excess NO₂ is also reduced through slower reaction leading to a lower total SCR reaction rate. Metal oxide catalysts such as V₂O₅ are developed mostly by synthesis routes such as impregnation, which normally produce nanoparticles of metal dispersed on support. The problem of such catalysts is the low performance, such as low NOx conversion and/or low N₂ selectivity.

Prior art catalysts have often used Cu, Fe, which are well recognized as good active sites for NH₃-SCR when incorporated into zeolite materials. As regards support materials, prior art has often used SiO₂, which has high specific surface area, and may be expected to improve SCR performance by increasing the quantity of active sites.

U.S. Pat. No. 9,283,548 B2 discloses catalysts of the type: MA/CeO₂ (M=Fe, Cu; A=K, Na), the synthesis route being impregnation, with chelating agents such as EDTA, DTPA being used.

J. Phys. Chem. B 2006, 110, 9593-9600 [Tian 2006] discloses catalysts of the type: VOx/AO₂ (A=Ce, Si, Z), the synthesis route being impregnation. Applications include propane oxidative dehydrogenation (ODH). Dispersion and physisorption of the vanadium oxo-isopropoxide is achieved, rather than chemisorption.

J. Phys. Chem. B 1999, 103, 6015-6024 [Burcham 1999] discloses catalysts of the type: Nb₂O₅/SiO₂, Al₂O₃, ZrO₂, TiO₂, the synthesis route being impregnation. The reference discusses surface species of isolated Nb, characterized by vibrational spectroscopy. The preparation is carried out in water, and the metal is deposited on the surface, rather than being grafted by protonolysis.

J. Phys. Chem. C 2011, 115, 25368-25378 [Wu 2011] discloses catalysts of the type: VOx/CeO₂, SiO₂, ZrO₂, the synthesis route being impregnation. Iso-propanol is used as a solvent, not leading to grafting of the precursor on the surface, but instead only dispersion and physisorption of the vanadium oxo-isopropoxide.

Appl. Catal. B 62, 2006, 369 [Chmielarz 2006] describes catalysts of the type: Fe or Cu/SiO₂ (3 different forms). It is widely known that Cu and Fe show good NH₃-SCR performance when zeolites are used (ion-exchange synthesis). The catalyst materials were used for deNOx by NH₃-SCR. Synthesis was carried out by molecular designed dispersion (MDD) using precursors Fe(acac)₃, Cu(acac) (acac=acetylacetonate).

Science 2007, 317, 1056-1060 [Avenier 2007] describes cleavage of dinitrogen on isolated silica surface-supported tantalum(III) and tantalum(V) hydride centers [(≡Si—O)₂Ta^{III}—H] and [(≡Si—O)₂Ta^{V}—H₃].

EP 2 985 077 A1 describes SiO₂-supported molybdenum or tungsten complexes, such as trialkyltungsten or molybdenum oxo complexes, their preparation and use in olefin metathesis.

### SUMMARY OF THE INVENTION

In order to address the problems associated with prior art products and processes in the field of ammonia selective catalytic reduction (NH₃-SCR) catalysts for nitrogen oxides (NOx) reduction, the processes and products of the present invention have been developed.

The Surface Organometallic Chemistry (SOMC) approach is capable of modifying the surface of support materials by grafting organometallic precursors, i.e. forming chemical bonds between precursors and surface hydroxyl groups, and thus preserving the local structure of the grafted material to minimize the formation of diversified species on the surface of support materials that are normally created through conventional synthesis methods. This methodology can be used to synthesize metal oxide catalysts supported with different metals. A typical SOMC procedure to synthesize materials consists of 3 steps as follows:
Step 1: Preparation, example:
   a Support materials:
      calcination
      hydratation
      dehydroxylation to generate controlled concentrations of hydroxyl groups
   Metal precursors:
      Synthesis (for those that are not readily available)
Step 2: Grafting
   Allow metal precursors to react with surface hydroxyl groups of the support material in a solution, for example toluene, typically at room temperature (˜25° C.)
   Washing and drying
Step 3: Activation
   Remove remaining organic ligands, typically by calcination at around 500° C. or higher in 16 h under air flow

The present invention discloses the development of new oxide NH₃-SCR catalysts with improved NOx reduction performance by using new SOMC procedures.

Thus, in a first aspect, the present invention relates to a process for preparing a catalyst material, comprising the steps of:
(a) providing a support material having surface hydroxyl (OH) groups, wherein the support material is ceria (CeO₂), zirconia (ZrO₂) or a combination thereof, and wherein the support material contains at least 0.3 mmol and at most 2.0 mmol OH groups/g of the support material;
(b) reacting the support material having surface hydroxyl (OH) groups of step (a) with at least one of the following:
(b1) a compound containing at least one alkoxy or phenoxy group bound though its oxygen atom to a metal element from Group 5 (V, Nb, Ta) or Group 6 (Cr, Mo, W);
(b2) a compound containing at least one hydrocarbon group bound though a carbon atom to a metal element from Group 5 (V, Nb, Ta) or Group 6 (Cr, Mo, W);
(b3) a compound containing at least one hydrocarbon group bound though a carbon atom to a metal element which is copper (Cu); and
(c) calcining the product obtained in step (b) in order to provide a catalyst material in which a metal element from Group 5 or Group 6, or Cu, is present as an oxide on the support material.

Thus, in a second aspect, the present invention relates to a catalyst material as may be obtained by the process set out above. In advantageous embodiments, the catalyst material of the invention contains at least 0.1 wt % and at most 5.0 wt %, more preferably at least 0.5 wt % and at most 2.0 wt %, of metal element from Group 5 (V, Nb, Ta) or Group 6 (Cr, Mo, W) or Cu, as measured by elemental analysis.

In a third aspect, the present invention relates to the use of the catalyst material set out above as an ammonia selective catalytic reduction (NH₃-SCR) catalyst for nitrogen oxides (NOx) reduction.

### BRIEF DESCRIPTION OF THE FIGS.

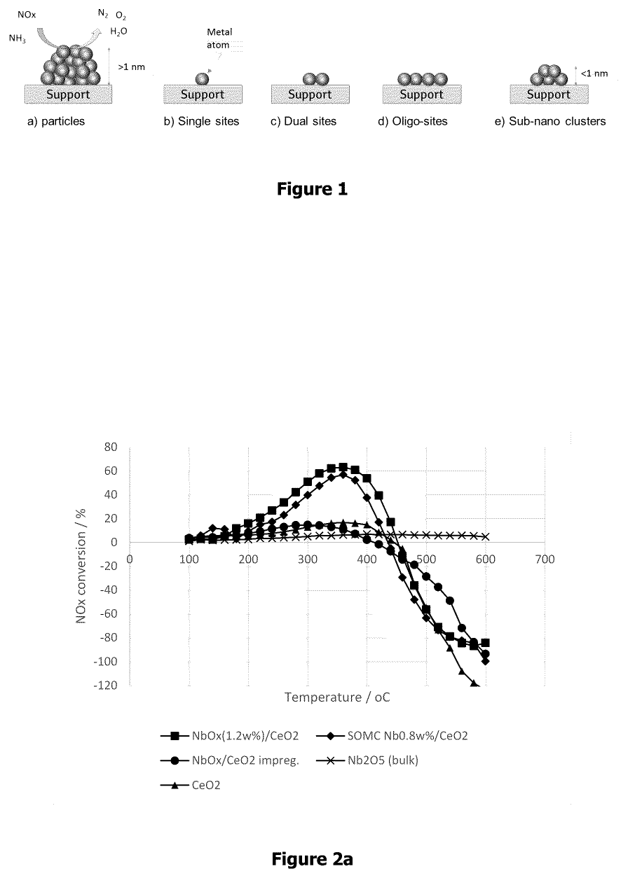

FIG. 1 shows a schematic representations of metal dispersion in catalysts synthesized by an SOMC approach (b,c,d,e) compared to nano-particle dispersion by conventional synthesis (a).

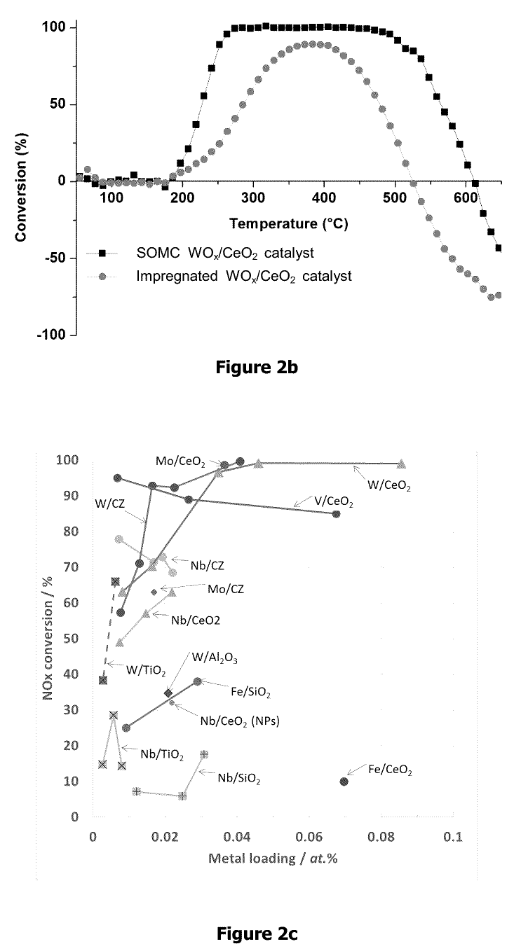

FIG. 2a shows the catalytic activity versus temperature profiles of 2 catalysts prepared by SOMC methodology, NbOx(0.8 wt %)/CeO₂ and NbOx(1.2 wt %)/CeO₂, in comparison to different materials, such as Nb₂O₅ bulk oxide, bare CeO₂ oxides, NbOx 1 wt %/CeO₂ prepared by impregnation. FIG. 2b shows the catalytic activity versus temperature profiles of two catalysts prepared from monomeric precursor and by classical water impregnation of (NH₄)₁₀H₂(W₂O₇)₆. FIG. 2c shows the NH₃-SCR activity of catalysts synthesized by SOMC methodology in comparison to those prepared by conventional methods (Nb-NP→Nb nanoparticles on CeO₂ prepared by impregnation) or by conventional methods in the prior art.

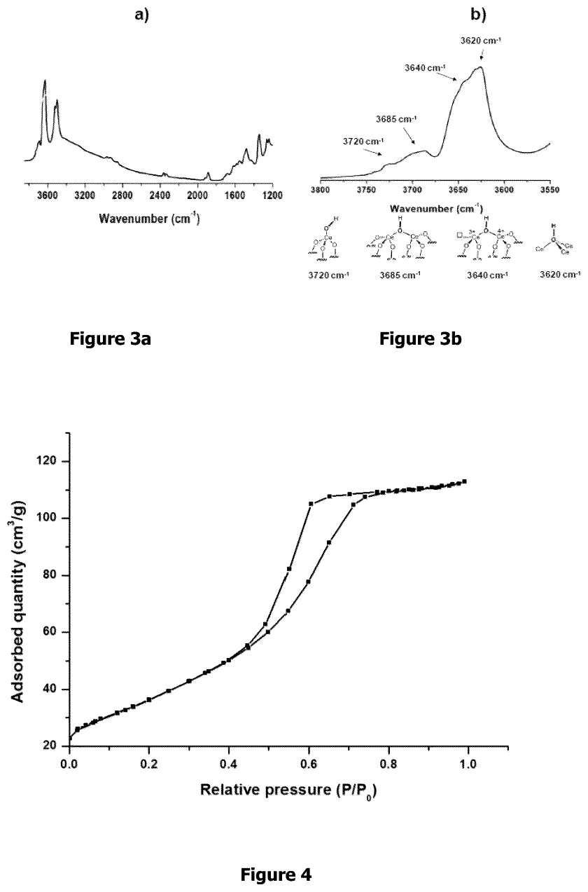

FIG. 3 shows a) DRIFT spectrum of ceria after calcination at 500° C., hydration at 25° C. and dihydroxylation at 200° C., b) attribution of (CeO-H) stretching vibration according to the literature.

FIG. 4 shows physisorption isotherms of nitrogen at 77K of ceria after dehydroxylation at 200° C.

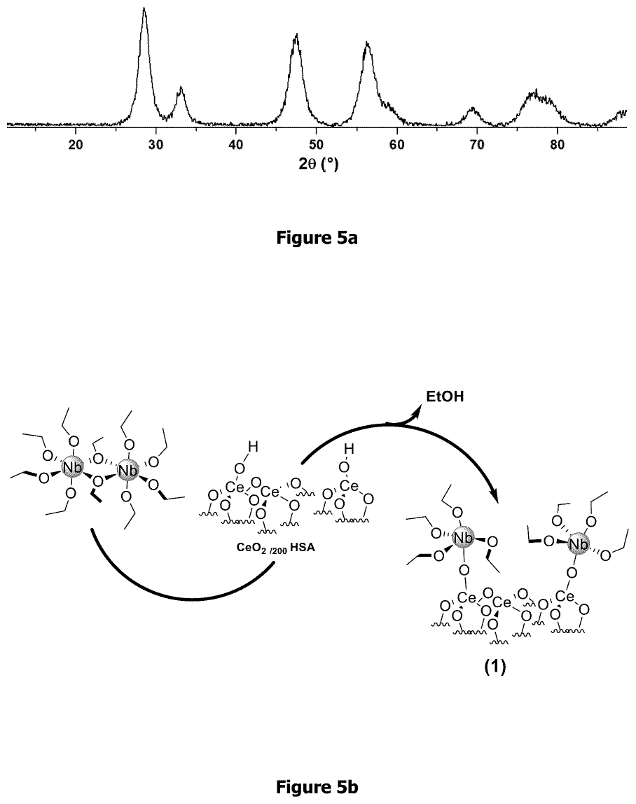

FIG. 5a shows a powder X-Ray diffraction pattern of a) ceria after pretreatment. FIG. 5b shows surface organometallic grafting of [Nb(OEt)₅]₂ with surface hydroxides of CeO₂ dehydroxylated at 200° C.

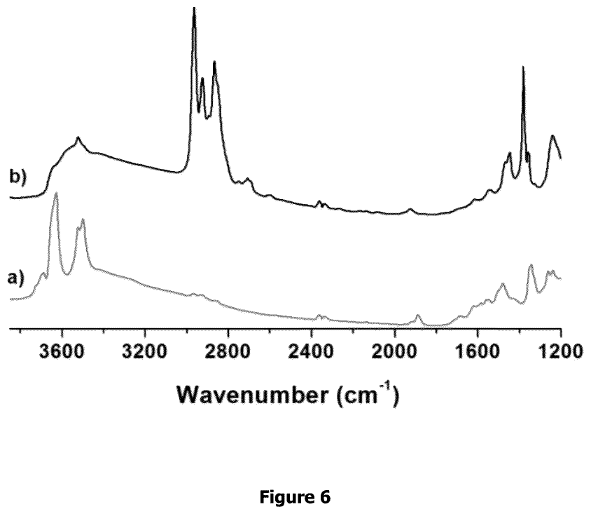

FIG. 6 shows DRIFT spectroscopy analysis spectra of a) ceria dehydroxylated at 200° C. (CeO₂-200) and b) after grafting of [Nb(OEt)₅]₂.

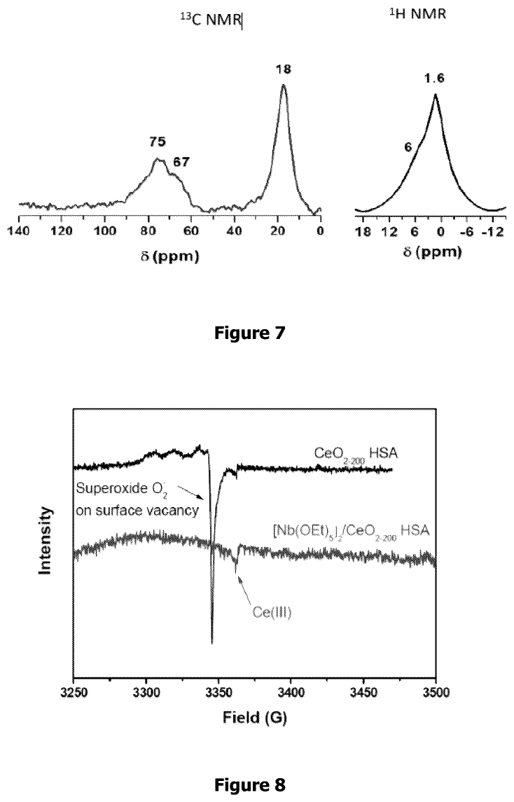

FIG. 7 shows ¹H and ¹³C CP MAS solid state NMR spectroscopy of the [Nb(OEt)₅]₂ grafted on ceria.

FIG. 8 shows the infrared electron paramagnetic resonance (EPR) spectra of ceria and [Nb(OEt)₅]₂/CeO₂.

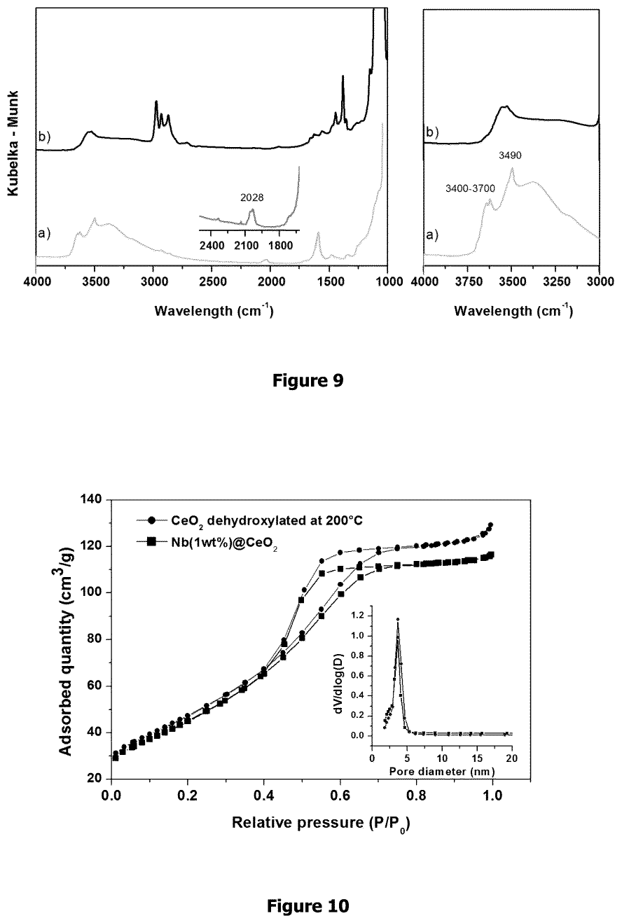

FIG. 9 shows DRIFT spectra of [Nb(OEt)₅]₂ grafted on ceria dehydroxylated at 200° C. (b) and final NbOx/CeO₂ after calcination at 500° C. under dry air (a).

FIG. 10 shows physisorption isotherms of nitrogen at 77K of the material containing 1.1 wt % of vanadium on ceria after calcination under dry air at 500° C. for 16 h.

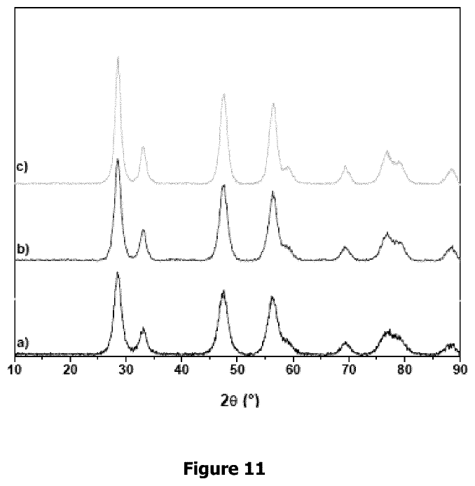

FIG. 11 shows powder X-Ray diffraction pattern of a) ceria, b) Nb(OEt)₅ grafted on ceria, c) NbOx on ceria catalyst.

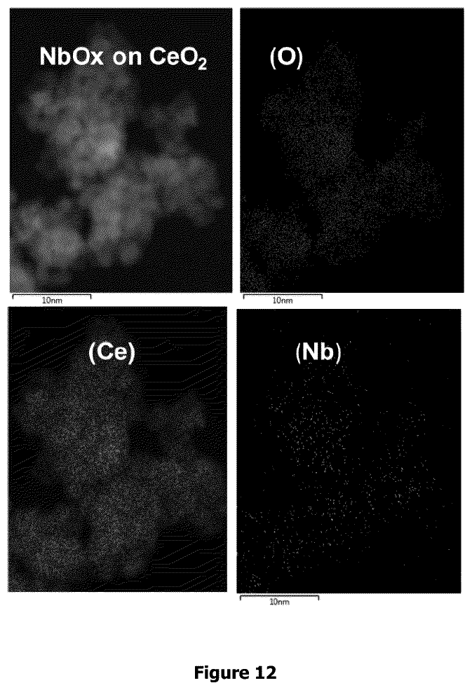

FIG. 12 shows EDX mapping of the catalyst (NbOx on ceria).

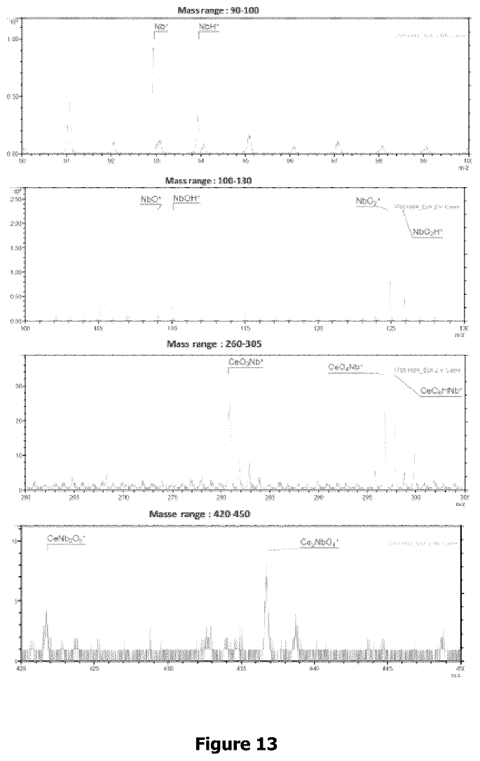

FIG. 13 shows Tof-Sims Polarity positive sampling catalysts NbOx/CeO₂ with 1.8% wt of niobium.

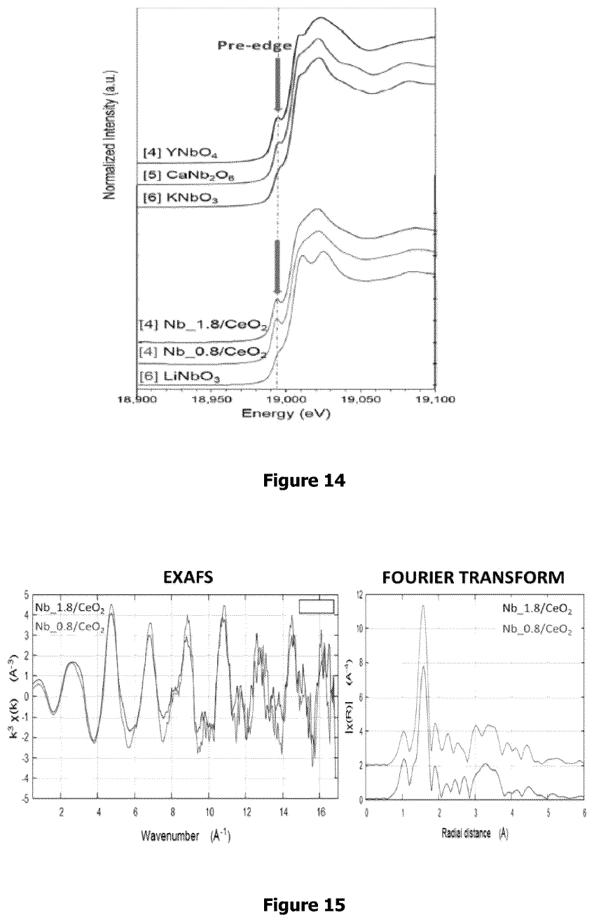

FIG. 14 shows Niobium K-edge XANES for samples with 0.8 and 1.8 wt % Nb loading compared with a known crystal where Nb is in coordination 4 ([4]), 5 ([5]) or 6 ([6]).

FIG. 15 shows Niobium K-edge k3-weighted EXAFS for samples with 0.8 and 1.8 wt % Nb loadings (left) and the corresponding modulus of the Fourier transform (right).

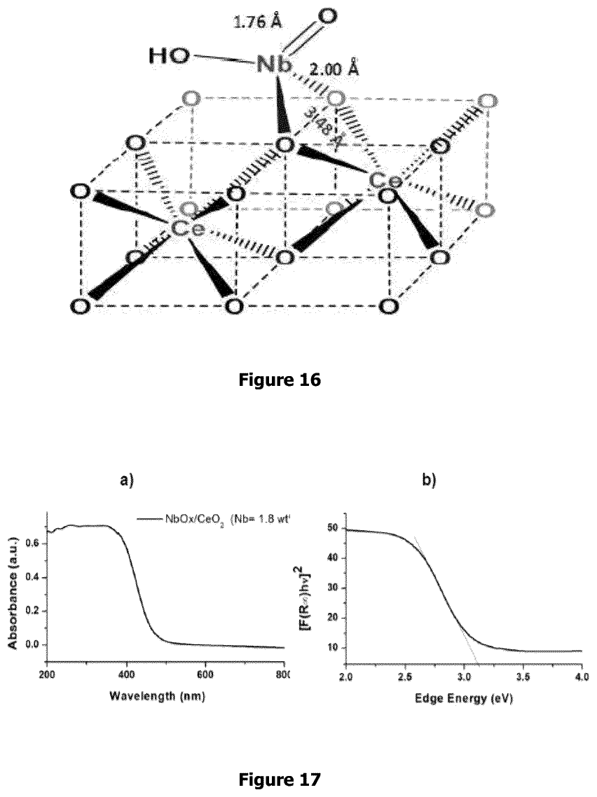

FIG. 16 shows the structure of the material NbOx/CeO₂ obtained after calcination of [Nb(OEt)₅]₂/CeO₂₋₍₂₀₀₎.

FIG. 17 shows a) Diffuse-reflectance Uv-Vis spectra of the NbOx/CeO₂ with 1.8 wt % content of Nb, b) UV-Vis DRS spectrum and edge energy value.

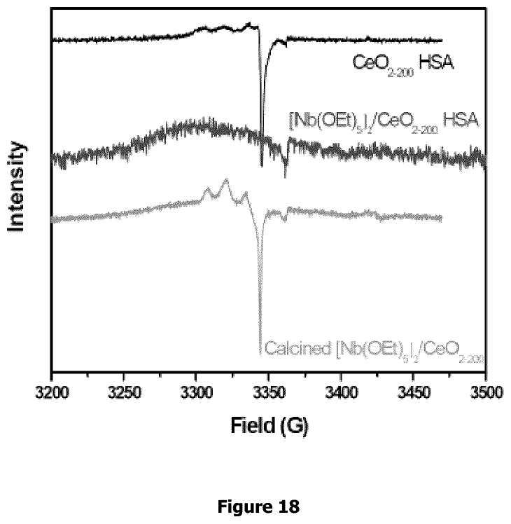

FIG. 18 shows the infrared electron paramagnetic resonance (EPR) spectra of ceria, [Nb(OEt)₅]₂/CeO₂ and NbOx/CeO₂.

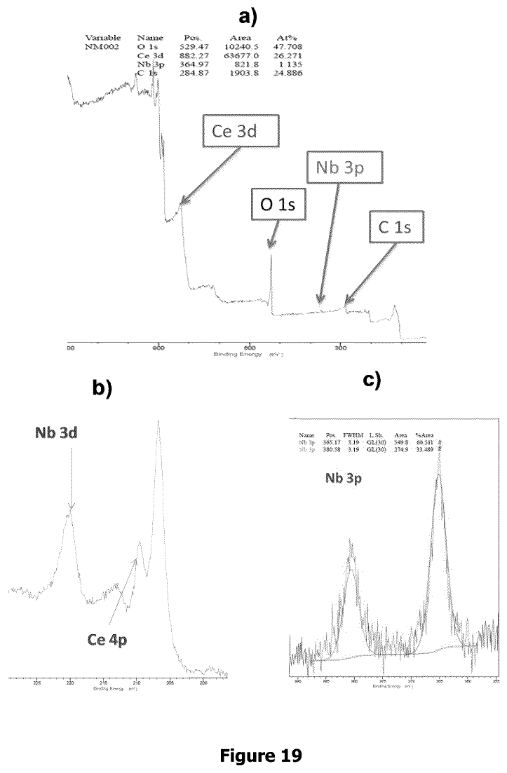

FIG. 19 shows XPS spectra of the catalyst NbOₓ/CeO₂ with 1.8 Wt % of Nb (a), Nb₃d and Nb₃p (b, c).

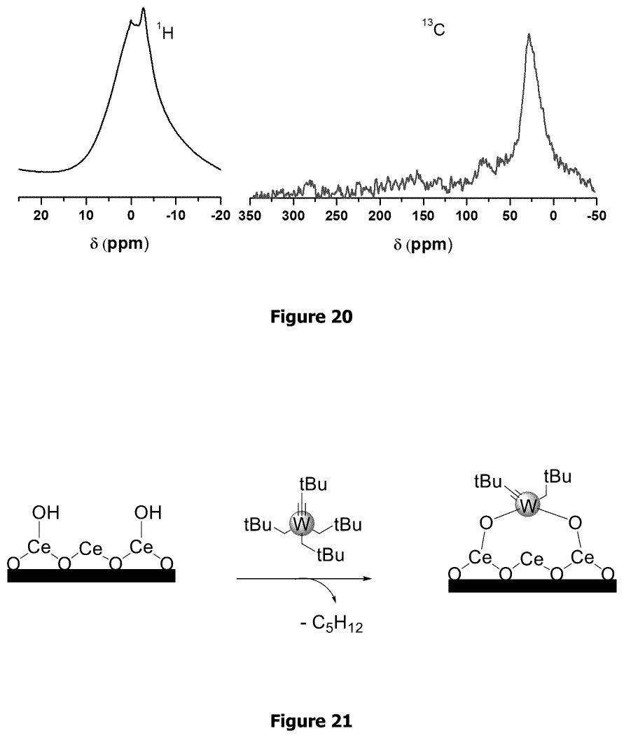

FIG. 20 shows the solid state NMR spectrum of ¹H MAS (eft) and ¹³C CP/MAS (right) of a W(≡*C^{t}Bu)(*CH₂^{t}Bu)₃/CeO₂₋₂₀₀ material.

FIG. 21 shows grafting of W(≡C^{t}Bu)(CH₂^{t}Bu)₃ on CeO₂₋₂₀₀

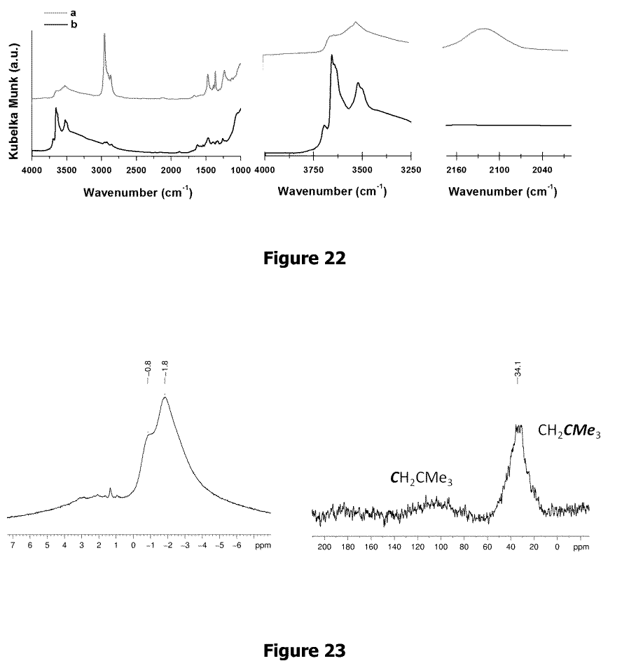

FIG. 22 shows DRIFT spectrum of a) ceria dehydroxylated at 200° C. b) after grafting of W(≡C^{t}Bu)(CH₂^{t}Bu)₃ (the two insets on the right are zoomed into specific wavenumber range).

FIG. 23 shows ¹H MAS (left) and ¹³C (right) NMR spectra of W(≡*C^{t}Bu)(*CH₂^{t}Bu)3/CeO₂₋₂₀₀.

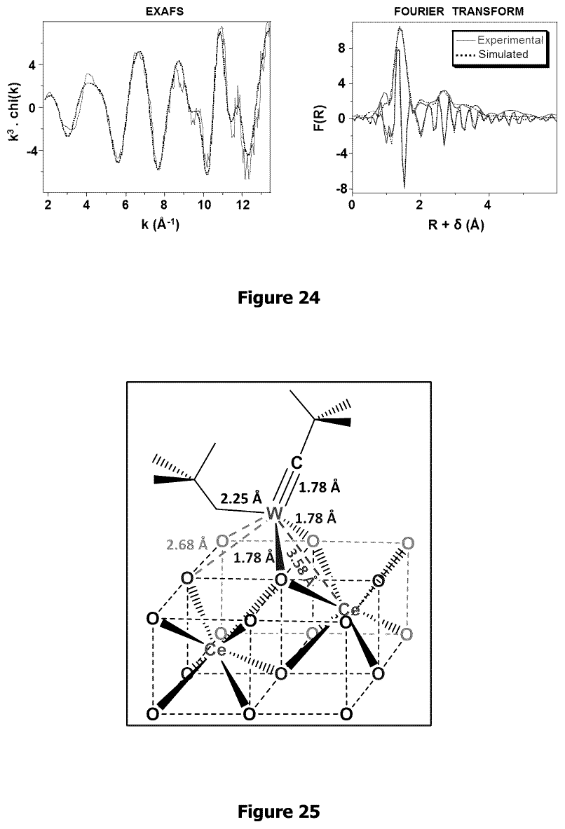

FIG. 24 shows W LIII-edge k3-weighted EXAFS (left) and Fourier transform (right) of solid W(≡C^{t}Bu)(CH₂^{t}Bu)₃/CeO₂₋₂₀₀ (solid lines are experimental and dashed lines: spherical wave theory=.

FIG. 25 shows a proposed structure for W(≡C^{t}Bu)(CH₂^{t}Bu)₃/CeO₂₋₂₀₀. ≡*C^{t}Bu)(*CH₂^{t}BuFIG. 26 shows DRIFT spectra of a) ceria dehydroxylated at 200° C., and b) after grafting of W(≡C^{t}Bu)(CH₂^{t}Bu)₃ after calcinations of W(≡C^{t}Bu)(CH₂^{t}Bu)₃/CeO₂₋₂₀₀.

FIG. 27 shows BET Surface Area analysis of W(≡C^{t}Bu)(CH₂^{t}Bu)₃/CeO₂₋₂₀₀ after calcination WOₓ/CeO₂₋₂₀₀)

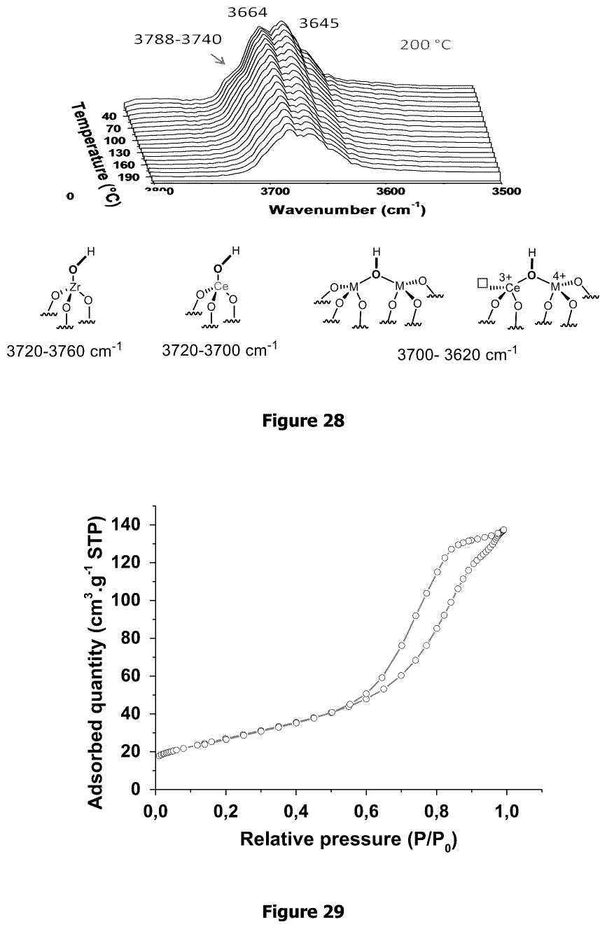

FIG. 28 shows in situ temperature-resolved DRIFT spectra of ceria-zirconia and attribution of different surface (MO-H) stretching vibration.

FIG. 29 shows physisorption isotherms of nitrogen at 77 K of ceria-zirconia after dihydroxylation at 200° C.

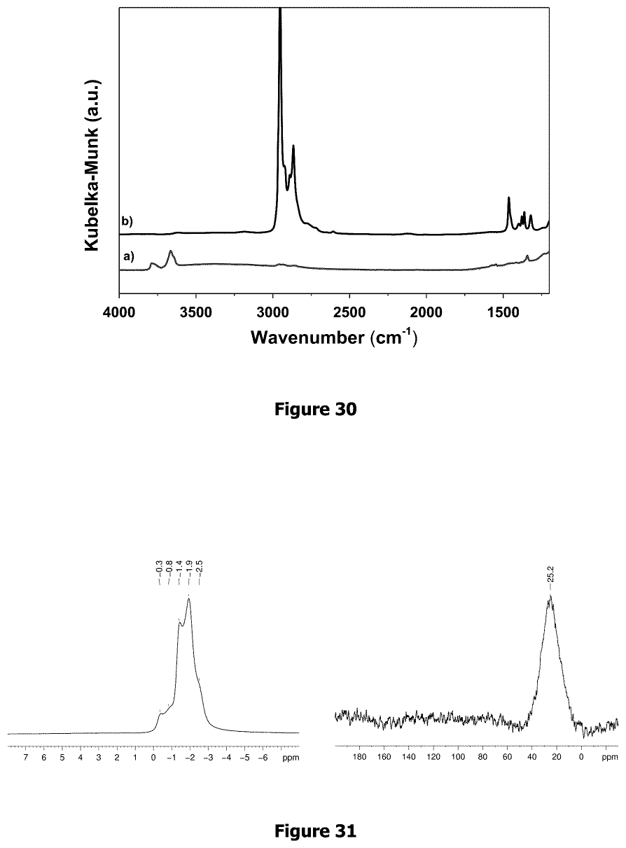

FIG. 30 shows the DRIFT spectrum of a) CeO₂—ZrO₂ dehydroxylated at 200° C., and b) after grafting of Al(iBu)₃.

FIG. 31 shows ¹H MAS (left) and ¹³C (right), NMR spectra of Al(iBu)₃/CeO₂—ZrO₂₋₂₀₀.

### DETAILED DESCRIPTION OF THE INVENTION

Catalysts in the present invention are believed to show features of atomic scale dispersion (cf. FIG. 1b-e), which results in high NH₃-SCR performance (FIG. 2). Catalysts produced according to the present invention may show high NOx conversion in NH₃-SCR reactions. Among advantageous features of the present invention are:
a process of grafting (chemical reactions between precursors and surface) rather than impregnating;
grafted metals with atomic scale dispersion rather than nano-particles;
a support which is thermally pre-treated (dehydroxylation), resulting in a desired anchoring point (OH), and where grafting yields well-dispersed surface species, thereby preventing sintering of the active metal center.

In the present invention, new NH₃-SCR catalysts with suitable combinations of a metal selected from transition metal groups such as V, Nb, Ta, W, Mo and a support material selected from CeO₂, ZrO₂ or their mixtures such as CeO₂—ZrO₂ are disclosed. These catalysts are prepared by new SOMC procedures using various organometallic metal precursors.

Conventional oxide catalysts normally consist of large metal particles supported on oxides. The active sites are ill-defined. The catalysts disclosed in the present invention may provide nearly 100% atomic scale dispersion of metal (cf. structure in FIG. 1b). Such highly dispersed metal sites are believed to not only simply give higher density of active sites but also to change the catalytic mechanism of NH₃-SCR, in which NH₃ adsorbed on metal sites can actively react with NOx adsorbed on surface of support. In other words, in the new catalysts, interaction between the metal and the support material is promoted, thus enhancing the catalytic performance.

FIG. 1 shows a schematic of metal dispersion in catalysts; conventional methods in the prior art produce mixtures of these species, where a large portion is in the form of nano particles (no quantitative estimation of isolated species). Catalysts reported in the prior art have a common problem of low NOx conversion in NH₃-SCR reactions. By contrast, catalysts produced according to the invention may show much higher NOx conversion in NH₃-SCR reactions compared to the conventional catalysts. FIG. 2a shows the catalytic activity versus temperature profiles of 2 catalysts prepared by SOMC methodology, NbOx(0.8 wt %)/CeO₂ and NbOx(1.2 wt %)/CeO₂, in comparison to different materials, such as Nb₂O₅ bulk oxide, bare CeO₂ oxides, NbOx 1 wt %/CeO₂ prepared by impregnation. An example of WOx/CeO₂ prepared by a SOMC process (details in Example 2b) is represented in FIG. 2b in comparison to impregnated catalysts with the same W loading of 3.2 wt. %. The NOx conversions over SOMC WOx/CeO₂ catalysts are higher over a wide range of temperature.

FIG. 2c shows that the highest NOx conversions of various catalysts with different combinations of metals/support materials synthesized by SOMC methodology are in comparison to those of catalysts synthesized following methods in the prior art (e.g. Fe/SiO₂ from Chmielarz 2006 cited above). Some other catalysts such as WOx/TiO₂, WOx/Al₂O₃, FeOx/CeO₂, NbOx/SiO₂ have also been prepared and tested for comparison; their low NOx conversions further prove that it is not easy to predict suitable metal/support combinations that yield high NH₃-SCR performance. It should be noted that these highest values (from each catalyst) shown here are not at the same temperatures but vary typically between 200-500° C. Many catalysts such as MoOx/CeO₂, WOx/CeO₂, WOx/CeO₂—ZrO₂ show 100% NOx conversions in wide range of temperatures, typically 200-500° C.

Appropriate support materials in the form of ceria (CeO₂) and/or zirconia (ZrO₂) can be obtained from commercial suppliers. For example, ceria can be obtained from suppliers such as SOLVAY and typically has a specific surface area of about 250 m²/g.

In an advantageous embodiment to provide a certain controlled concentration of OH groups on the support material, in order to provide the material in step (a) of the process of the invention, hydration of the oxide support material (as received in a typical commercial sample) may be carried out in a first instance using moisture, followed by dihydroxylation through heating under reduced pressure. The concentration of OH groups is notably influenced by the temperature of the treatment. In a generally appropriate process for treating a ceria (CeO₂) support material, a pressure of about 10⁻⁵ mbar, at a temperature of 200° C. for typically 16 h constitute advantageous treatment conditions. The concentration of OH groups on the support material can for example be determined by chemical titration through reaction with Al(ⁱBu)₃— the latter reacts quantitatively with surface hydroxyl groups releasing one equivalent of isobutane per OH group.

Preferred support materials in the present invention are ceria (CeO₂) or ceria-zirconia (CeO₂—ZrO₂) supports. Concerning the mixed ceria-zirconia (CeO₂—ZrO₂) support, the amount of ZrO₂ can be in the range 20-80 wt %, preferably between 30-60 wt %. A higher content of ZrO₂ may in practice decrease the concentration of OH groups. CeO₂ and CeO₂—ZrO₂ are not known in the prior art as good support materials for SCR catalysts—these materials normally have lower specific surface area (SSA) than SiO₂.

In grafting step (b) of the invention, the support material having a controlled concentration of hydroxyl groups (OH) is reacted with one of three types of grafting reagent, according to process variants (b1) to (b3).

According to process variant (b1), a support material having a controlled concentration of hydroxyl groups (OH) is reacted with a compound containing at least one alkoxy or phenoxy group bound though its oxygen atom to a metal element from Group 5 (V, Nb, Ta) or Group 6 (Cr, Mo, W). In these compounds, the Group 5 or 6 metal atom is linked through an oxygen atom to a carbon atom of an alkyl group, the alkyl group being able to be substituted, or is linked through an oxygen atom to a carbon atom of an aryl group, the aryl group being able to be substituted. The Group 5 or 6 metal atom may have, apart from one or more alkoxy or phenoxy groups, other types of groups bound thereto, such as unsubstituted oxygen (formally double-bonded to the metal atom). Exemplary compounds containing at least one alkoxy or phenoxy group bound though its oxygen atom to a metal element from Group 5 (V, Nb, Ta) or Group 6 (Cr, Mo, W) include: [Nb(OEt)₅]₂; Nb(OAr)₅ where Ar is the 1,3,5-trimethylphenyl (CH₃)₃C₆H₂— group; [W=O(OEt)₄]₂; [V(═O)(OEt)₃]₂; [V(═O)(OⁱPr)₃]; and [Ta(OEt)₅]₂.

According to process variant (b2), a support material having a controlled concentration of hydroxyl groups (OH) is reacted with a compound containing at least one hydrocarbon group bound though a carbon atom to a metal element from Group 5 (V, Nb, Ta) or Group 6 (Cr, Mo, W). The hydrocarbon group in this instance may be an alkyl or aryl group, and the Group 5 or 6 metal atom may have, apart from one or more alkyl or aryl groups, other types of groups bound thereto, such as unsubstituted oxygen (formally double-bonded to the metal atom). Exemplary compounds containing at least one hydrocarbon group bound though a carbon atom to a metal element from Group 5 (V, Nb, Ta) or Group 6 (Cr, Mo, W) include: W≡C^{t}Bu(CH₂^{t}Bu)₃; and Mo(O)₂Mesityl₂.

According to process variant (b3), a support material having a controlled concentration of hydroxyl groups (OH) is reacted with a compound containing at least one hydrocarbon group bound though a carbon atom to a metal element which is copper (Cu). The hydrocarbon group in this instance may be an alkyl or aryl group, and the copper (Cu) metal atom may have, apart from one or more alkyl or aryl groups, other types of groups bound thereto, such as unsubstituted oxygen (formally double bonded to the metal atom). Exemplary compounds containing at least one hydrocarbon group bound though a carbon atom to a metal element which is copper (Cu) include: [Cu₅(Mes)₅].

Concerning the functionalization (grafting) stage, generally appropriate solvents include apolar solvents, such as in particular hydrocarbon solvents. Specific example of solvents include: pentane, hexane, heptane, toluene, xylenes, and mesitylene. In terms of reaction conditions for grating, temperatures may range from room temperature up to reflux conditions and the reaction time may appropriately be from 1 hour to 60 hours.

Concerning the activation (calcination) process, the activation process may be carried out at temperatures from 200° C. — 700° C., preferably between 300° C. and 500° C. Calcination may appropriately be carried out in an oxygen-containing atmosphere, such as dry air.

In preferred embodiments of the invention, the process is carried out such that the compound obtained in step (b1) or (b2) has at least 0.1 wt % and at most 5.0 wt %, preferably at least 0.5 wt % and at most 2.0 wt %, of metal element from Group 5 (V, Nb, Ta) or Group 6 (Cr, Mo, W) or Cu, as may be determined in elemental analysis of the compound obtained in step (b1) or (b2).

In preferred embodiments of the invention, the process is carried out such that the compound obtained after calcining step (c) has at least 0.1 wt % and at most 5.0 wt %, preferably at least 0.5 wt % and at most 2.0 wt %, of metal element from Group 5 (V, Nb, Ta) or Group 6 (Cr, Mo, W) or Cu, in elemental analysis of the compound obtained after calcining step (c).

In preferred embodiments of the present invention, Group 5 or Group 6 metals are used, which are not known as good active sites for NH₃-SCR when incorporated into zeolite materials. Although metals from these groups may have been used as NH₃-SCR catalysts in single form such as V₂O₅, it was not expected that they would show high NH₃-SCR performance when dispersed over other oxides as support materials. It is therefore considered by the present inventors that it was not easy to predict that the proposed combinations of the metals and support materials in the present invention would lead to significantly improved NH₃-SCR performance, or that atomic scale dispersion of metals over oxides would significantly improve NH₃-SCR performance.

Catalyst materials of the present invention can interact with gas reactants in a catalytic process. In certain embodiments the catalyst materials may be applied to an inert substrate such as a metal plate, corrugated metal plate, or honeycomb. Alternatively, the catalyst material may be combined with other solids such as fillers and binders in order to provide an extrudable paste that may be transformed into a porous structure such as a honeycomb.

A catalytic converter based on catalyst materials of the present invention may appropriately include the catalyst material disposed on a supporting element such that passages are made available for the passage of exhaust gases, and the supported catalyst material may appropriately be housed in a metal casing. The metal casing is generally connected with one or more inlets such as pipes for transferring exhaust gases towards the catalyst material.

In order to function in NH₃-SCR catalysis, the catalytic converter is appropriately connected with a source of ammonia in order for the latter to come into contact with exhaust gas. The ammonia can be provided as anhydrous ammonia, aqueous ammonia, urea, ammonium carbonate, ammonium formate, or ammonium carbamate. In some embodiments, an ammonia storage tank is used to contain the ammonia source.

An SCR system can be integrated into various systems that require NOx reduction. Applications include engine systems of a passenger vehicle, truck, utility boiler, industrial boiler, solid waste boiler, ship, locomotive, tunnel boring machine, submarine, construction equipment, gas turbine, power plant, airplane, lawnmower, or chainsaw. Catalytic reduction of NOx using catalyst materials according to the present invention is therefore of general interest in situations where fossil fuels are used for power generation, not just for transportation but also in power generation devices, and domestic appliances using fossil fuels.

Within the practice of the present invention, it may be envisaged to combine any features or embodiments which have hereinabove been separately set out and indicated to be advantageous, preferable, appropriate or otherwise generally applicable in the practice of the invention. The present description should be considered to include all such combinations of features or embodiments described herein unless such combinations are said herein to be mutually exclusive or are clearly understood in context to be mutually exclusive.

### EXPERIMENTAL SECTION

### Examples

The following experimental section illustrates experimentally the practice of the present invention, but the scope of the invention is not to be considered to be limited to the specific examples that follow.

### Example 1a

### Preparation of of NbOx/CeO₂ Using [Nb(OEt)₅]₂ as Precursor

### Step 1: Pre-Treatment of Support Material, Ceria (CeO₂)

Ceria Actalys HAS-5 Actalys 922 from Solvay (Rare Earth La Rochelle), CeO₂₋₍₂₀₀₎ (ceria with specific surface area of 210±11 m² g⁻¹), was calcined for 16 h at 500° C. under a flow of dry air, and evacuated under vacuum at high temperature. After moisture, re-hydratation under inert atmosphere the ceria was partially dehydroxylated at 200° C. under high vacuum (10⁻⁵ Torr) for 15 h to give a yellow solid having a specific surface area of 200±9 m².g⁻¹.

The support ceria was characterized by DRIFT, BET, NMR and XRD.

### Characterization of Ceria by DRIFT

The DRIFT study depicted in FIG. 3 showed that the thermal treatment under vacuum (10⁻⁵ mbar) at 200° C., after calcination and hydration, resulted in the removal of physisorbed water and mainly showed bridged OH group. The spectrum of ceria dehydroxylated at 200° C. pictured in FIG. 3a) showed four vibration bands attributed to different structures of surface CeₓO—H (terminal and bridging OH) depicted in FIG. 3b). The intensity of the band at 3712 cm⁻¹ of the isolated OH is weak and the IR signal is rather dominated by the broad signal centered at 3630 cm⁻¹ of bridged hydroxyl groups. This fact may suggest that this ceria shows a low amount of (1 0 0) facets, and (111 facets) are dominant. In addition, a large band the ν(OH) centered at 3527 cm⁻¹ corresponds to a residual cerium on/hydroxide phase located within the pores.

### Titration of Hydroxyl Groups of Ceria

To achieve the grafting and the functionalization of surface hydroxides under optimum conditions, it is desirable to know their amount. Among the reliable quantification methods is chemical titration by reacting them using Al(ⁱBu)₃. This latter is known to react quantitatively with surface hydroxyl groups releasing one equivalent of isobutane per OH. The quantification of isobutane by GC shows that Al(ⁱBu)₃ reacts with OH groups of ceria giving 0.7 mmol OH/g.

### Surface Area of Ceria After Dehydroxylation at 200° C.

The BET surface area measured for the resulting material (FIG. 4) was found to be ca. 207 ±10 m²/g.

### Characterization of Ceria Dehydroxylated at 200° C. by XRD

The X-ray diffraction analyses revealed that the crystalline cubic fluorite structure is preserved with the pretreatment (calcination at 500° C. under air and dihydroxylation at 200° C.) (FIG. 5a). The XRD pattern of the ceria and ceria after treatment are identical. This observation suggests that the calcination at 500° C. followed by hydration and dihydroxylation at 200° C. did not affect the crystalline structure of the support. From the diffraction pattern the mean size of microcrystals could be evaluated, since it is related to diffraction peak broadening by Scherer's equation. The average crystal size found was about 4 nm for ceria.

Step 2: Grafting precursor [Nb(OEt)₅]₂ on CeO₂₋₍₂₀₀₎

Grafting was performed either in a glove box or using a double Schlenk technique. The latter approach enabled the extraction of the unreacted complex through washing and filtration cycles.

A mixture of a desired amount of [Nb(OEt)₅]₂ and CeO₂(200) (4 g) in toluene (20 ml) was mixed at 25° C. for 4 h. After filtration, the solid [Nb(OEt)₅]₂—CeO₂₋₍₂₀₀₎ was washed three times with 10 ml of toluene and 10 ml of pentane. The resulting powder was dried under vacuum (10⁻⁵ Torr) (see FIG. 5b). The intermediate products were characterized by DRIFT, NMR, ICP.

Characterization of the Intermediate [Nb(OEt)₅]₂/CeO₂₋₍₂₀₀₎ by DRIFT

The grafting reaction of [Nb(OEt)₅]₂/CeO₂₋₍₂₀₀₎ on ceria to form [Nb(OEt)₅]₂/CeO₂₋₍₂₀₀₎ is monitored by DRIFT spectroscopy (FIG. 6). After the grafting reaction and the removal of the excess complex, the bands between 3400 and 3700 cm⁻¹ attributed to different vibration mode of (CeO-H) at 3747 cm⁻¹ completely disappeared. New bands in the 3100-2850 cm⁻¹ range and between 1620-1400 cm⁻¹ are observed, these peaks being characteristic of aliphatic v(C—H) and δ(C—H) vibrations of the chemisorbed ligands on surface. This confirms the chemical reaction between surface hydroxyl groups of ceria with niobium ethoxide precursor by protonolysis and formation of ethanol.

Characterization of the Intermediate [Nb(OEt)₅]₂/CeO₂₋₍₂₀₀₎ by Elemental Analysis

Mass balance measurement carried out on this material ([Nb(OEt)₅]₂©CeO₂₋₍₂₀₀₎ showed the presence of 1.8 wt % and 1.41 wt % of Nb and C respectively (C/Nb=6.1). This strongly suggests that the structure of the niobium ethoxy fragments are bipodal dimeric species on the surface of the ceria (FIG. 5b). The ethanol produced during the grafting was not evaluated, as it remains strongly bonded to the surface.

Characterization of the Intermediate [Nb(OEt)₅]₂/CeO₂₋₍₂₀₀₎ by Solid State NMR

The characterization of the resulting material [Nb(OEt)₅]₂@CeO₂₋₍₂₀₀₎) was performed by ¹H and ¹³C CP MAS solid state NMR spectroscopies (FIG. 7). The ¹H MAS NMR spectrum shows broad signals at 1.6 ppm and a shoulder at 6 ppm attributed to —OCH₂CH₃ and —OCH₂CH₃ of the ethoxy ligands of niobium and the ethanol that can remain coordinated to the surface of the support (ethanol being released during the grafting process). Moreover, ¹³C CP MAS NMR data displayed signals at 18 ppm and 80 ppm, assigned to the terminal —OCH₂CH₃ and —OCH₂CH₃ groups respectively. Likewise, the peaks at 67 correspond to the OCH₂CH₃ groups of ethanol coordinated to the support. This observation implies that the complex of niobium ethoxide is grafted onto ceria.

Step 3: Calcination of the Intermediate [Nb(OEt)₅]₂/CeO₂ to obtain catalyst {NbOx}-CeO₂₋₍₂₀₀₎

The material [Nb(OEt)₅]₂/CeO₂₋₍₂₀₀₎ was calcined using a glass reactor under continuous flow of dry air at 500° C. for 16 h. The recovered material {NbOx}-CeO₂₋₍₂₀₀₎ prior to a catalytic test was characterized. Different samples were prepared by this procedure: 0.4 to 1.83 wt % of Nb. The characterization of a sample with 1.82 wt % of Nb is presented below.

### Characterization of NbOx/CeO₂ (Samples 1.8 wt Nb %) by EPR

Electron paramagnetic resonance (EPR) spectrum of the ceria (FIG. 8) showed a signal at g=2.011 specific for O₂⁻ species. The peak disappeared with the grafting of the Nb complex and appearance of a weak signal at g₁=1.95 specific for Ce³⁺ on CeO₂.

Characterization by DRIFT of NbOx/CeO₂ (sample 1.8 wtNb %)

The infrared spectrum (FIG. 9) shows a disappearance of the ν(C—H) and δ(C—H) bands, indicating the total decomposition of the organic fragments. Moreover, new bands in the region of OH stretching vibration are observed between 3400 and 3700 cm⁻¹ attributable to ν(CeO—H) and at 3490 cm⁻¹ assignable to ν(NbO—H).

### Characterization of NbOx/CeO₂ (Sample 1.8 wt % Nb) by BET

The BET surface area measured for the resulting material (FIG. 10) was found to be ca. 186±9 m²/g, close to the one found for the neat ceria calcined under the same conditions, which was ca. 207±10 m²/g. This would seem to imply that the crystal structure is preserved and the grafting as well as the calcination process induces no particle sintering. Moreover, the pore volumes showed a slight decrease from^{0.7} cm³/g to ca. 0.6 cm³/g due the presence of organometallic fragments that occupy a certain amount of the volume.

Characterization of NbOx/CeO₂ (sample 1.8 wtNb %) by X-Ray Diffraction

The X-ray diffraction analyses revealed that the crystalline cubic fluorite structure is preserved with the pretreatment (calcination at 500° C. under air and dihydroxylation at 200° C.) (FIG. 11). The XRD pattern of the ceria and NbOx/CeO₂ after calcinations are identical. This observation suggests that the functionalization did not affect the crystalline structure of the support and niobium oxide species are below the detection limit and uniformly distributed on the surface. From the diffraction pattern, the mean size of microcrystals could be evaluated, since it is related to diffraction peak broadening by Scherrer's equation. The average crystal size found was about 4 nm for ceria and increases with the thermal treatment to reach 6 nm for the catalysts NbOx/CeO₂.

Characterization of NbOx/CeO₂ (sample 1.8 wtNb %) by EDX

The energy dispersive analysis (EDX) mapping performed on the catalyst NbOx_{1.8}/CeO₂ (FIG. 12) showed that the niobium atoms are well distributed on the ceria surface, and the structure of Nb is mainly isolated elements.

Characterization of NbOx/CeO₂ (Samples 1.8 wtNb %) by Tof-Sims

The majority of the detected species after irradiation by secondary ion mass spectrometry (SIMS) is a technique used to analyse the composition of solid surfaces and thin films by sputtering the surface of the specimen with a focused primary ion beam and collecting and analysing ejected secondary ions.

The mass/charge ratios of these secondary ions are measured with a mass spectrometer to determine the elemental, isotopic, or molecular composition of the surface to a depth of 1 to 2 nm. Tof-Sims (FIG. 13) species detected are monomeric (Nb⁺, NbOₓ^{+/-}, CeₓNbO_{y}^{+/-}), with some traces of dimeric species (Nb₂O₅⁻, Nb₂O₆⁻, CeNb₂O₆⁺, Ce₂Nb₂O₇⁺, Ce₃Nb₂O₉⁺), and no polymeric species detected by means of this characterization technique.

### Characterization of NbOx/CeO₂ (Samples 0.8, 1.2 and 1.8 wt. % Nb) by XAS

Three samples with Nb loadings of 0.8, 1.2 and 1.8 wt. % were studied by X-ray absorption spectroscopy (FIGS. 14 and 15) in order to determine the structure of the supported species. The XANES data suggested that the Nb species on the cerium oxide surface, with a spectrum showing an important pre-edge signal, are in a tetrahedral environment. The parameters extracted from the fit of the EXAFS (FIG. 16 and Table 1) of the most loaded sample (1.8 wt %) are in agreement with an (O₃ Nb(═O) structure, with ca. one oxygen atom at 1.76(2) Å, attributed to an oxoligand and ca. three oxygen atoms at 2.005(20) Å, attributed most probably to two surface oxide ligands and one hydroxyl ligand. The fit could be also improved by adding a further layer of back-scatters, with only ca. one cerium atom at 3.54(3) Å. The inclusion of niobium as a second neighbour, was not statistically validated. Therefore, this EXAFS study is in agreement with the (O)₃Nb(═O) tetrahedral structure represented below in FIG. 5b, with one Ce atom from the surface as a second neighbour (Table 1).

In conclusion, it was observed by the aforementioned techniques (notably EDX and EXAFS) that the niobium is well distributed on the ceria surface, and the structure of Nb is mainly isolated bipodal species bearing oxo hydroxo ligands (in Table 1).

TABLE 1
EXAFS parameters for the niobium species
at the surface of cerium oxide^{a}

| Type of neighbour | No. of neighbours | Distance (Å) | σ² (Å²) |
|---|---|---|---|
| Nb═O | 0.8(2) | 1.76(2) | 0.0030(26) |
| Nb—OCeₓ | 2.9(7) | 2.0005(20) | 0.0041(17) |
| Nb—O—Ce | 0.7(5) | 3.54(3) | 0.0034(15) |
| (Nb—Nb) | 0.1(4) | 3.32(3) | 0.006(5) |

The errors generated by the EXAFS fitting program “RoundMidnight” are indicated in parentheses.
^{a}Δk: [2.8-16.2 Å⁻¹] − ΔR [1.0-3.9 Å]; Fit residue: ρ = 9.7%

Characterization of NbOx/CeO₂ (Samples 1.8 wtNb %) by UV-Vis

A satisfactory understanding of the overall dispersion of the niobium ad-species was provided by UV-Vis-DRS analysis (FIG. 17). This has been largely used to elucidate the structure of supported NbOx and mixed oxides containing Nb. More specifically, it has been demonstrated that the UV-vis DRS edge energy of the ligand to metal charge transfer (LMCT) transitions, Eg (eV) bears a linear relationship to the number of bridging Nb—O—Nb bonds for an NbOx coordinated structure. The presence of a strong absorbing material can entail and cause distortions of the DRS spectra and affect the consistency of the Eg value. Unfortunately this is the case in the present work where the LMCT transitions of the Nb(5) cations and the support CeO₂ overlap. However, it was demonstrated that this effect can be mitigated either by dispersing the sample in a transparent matrix such as MgO, SiO₂, and Al₂O₃, or by considering the support as a baseline reference. The peak at 299 nm is presumably due to the tetrahedral Nb(IV) in the monomeric species. The peaks at 346 and 399 nm are most likely due to the octahedral Nb(5) monomeric and polymeric species respectively. Bands characteristic of crystalline Nb₂O₅ and CeVO₄ phases were not found. In addition, the band at 259 nm attributable to the charge-transfer transitions between oxygen and Nb(IV) in a tetrahedral coordination of the polymeric species unfortunately overlaps with the bands of ceria due to Ce³⁺O⁻² and Ce⁴⁺O⁻² charge transfers.

Characterization of NbOx/CeO₂ (Samples 1.8 wtNb %) by EPR

After the calcination at 500° C. under dry air, the electron paramagnetic resonance spectrum (EPR) depicted in FIG. 18 showed a signal (g=2.011) attributable to O₂⁻ radicals, while the amount of Ce⁺³ is conserved, presumably due to those coordinated to Nb.

Characterization of NbOx/CeO₂ (Samples 1.8 wtNb %) by XPS

X-ray photoelectron spectroscopy was used to examine the electronic state of the niobium and ceria support (FIG. 19). The spectrum of Ce (3d), O (1s) and Nb (3d) and (3p) for the oxidized catalyst NbOx/CeO₂ containing 1.8 wt % of Nb. Generally, eight features are found in the Ce 3d region due to the pairs of spin orbit doublets. O 1s showed spectrum tow binding energy at 529. 6, 531 and 532 eV assigned to lattice oxygen and to surface oxygen (O₂⁻ and O⁻) respectively. The spectrum fittings also highlighted the presence of both V3p/2

and V3p1/2 of V(V) with BE values at 365 and 380 eV.42. The fraction of Ce³⁺ ions for CeO₂ support was estimated to be 24%.

### Example 1b

### Preparation of [NbOx]/CeO₂₋₍₂₀₀₎ by Using [Nb(OAr)₅] as precursor where Ar is 2,6-diisopropyl-phenyl

Step 1: Pretreatment of support material, CeO₂

The pretreatment of the support material was performed in the same way as for the pretreatment of the support in step 1 of Example 1a above.

Step 2: Grafting [Nb(Oar)₅] precursor on CeO₂₋₍₂₀₀₎

A mixture of [Nb(Oar)₅] (1.225 mg, 1.75 mmol) and CeO₂₋₍₂₀₀₎ (2.5 g) in toluene (20 mL) was stirred at 25° C. for 12 h. After filtration, the solid [Nb(Oar)₅]/CeO₂₋₂₀₀ was washed three times with toluene. The resulting yellow powder was dried under vacuum (10⁻⁵ Torr). ¹H MAS NMR (ppm, 500 MHz): δ 6.4 (Oararomatic proton), 1.8 (ArMe proton of methyl) ¹³C CP MAS NMR (ppm, 200 MHz): δ 158.7 (ipso Oar C-iPSO of aryl), 118.5-126.8 (Oar aromatic carbon), 16.7 (ArCH₃ methyl). Elemental analysis % Nb=0.99% wt % C=5.19% wt C/Nb=40.6 (th 32).

### Step 3: Calcination

The material [Nb(Oar)_{5]}/CeO₂-200 was calcined using a glass reactor under a continuous flow of dry air at 500° C. for 16 h. The recovered material prior to catalytic test was characterized. The DRIFT analyses showed the complete disappearance of CH group of the aryloxy moieties and the apparition of a new signal around 3690 cm⁻¹ attributed to hydroxyl group (Nb—OH, and Ce—OH). The surface area measurement of the catalyst indicated a surface of ca. 135 m²/g after calcination.

### Example 2a

### Preparation of Wox/CeO₂ by using [W=O(Oet)₄]₂ as Precursor

A mixture of [W=O(Oet)₄]₂ (0.625 g, 1 mmol) and 6 g CeO₂₋₍₂₀₀₎ in toluene (30 mL) was stirred at 25° C. for 12 h. After filtration, the obtained solid [W=O(Oet)_{4 ] 2}/CeO₂ was washed three times with toluene in order to extract the unreacted complex and then with pentane to remove toluene. The resulting yellow powder was dried under vacuum (10⁻⁵ Torr).

¹H MAS NMR (ppm, 500 MHz): δ 4.8 (OCH₂CH₃), 1.3 (OCH₂CH₃) ¹³C CP MAS NMR (ppm, 200 MHz): δ 68.5 (terminal OCH₂CH₃), 64.6 (bridging OCH₂CH₃), 18.3 (terminal OCH₂CH₃), 16.5 (bridging OCH₂CH₃). Elemental analysis % W=4.1 Wt% % C=1.2% wt C/W=4.5 (th 6). The DRIFT analyses showed that the bands at higher wavenumbers (v(OH)=3400-3700 cm⁻¹) corresponding to Ce—OH reacted selectively with tungsten complex. In addition, bands characteristic of v(C—H) and δ(C—H) in the 2850-3050 and 1110-1470 cm⁻¹ region respectively are found.

The material [W=0(OEt)₄]₂/CeO₂ was calcined using a glass reactor under a continuous flow of dry air at 500° C. for 16 h. The recovered material prior to a catalytic test was characterized. The DRIFT analyses showed the complete disappearance of CH group of the ethoxy moieties and the apparition of a new signals around 3690 cm⁻¹ attributed to hydroxyl group (W—OH, and Ce—OH). The surface area of the catalyst indicated a decrease of the surface area to 145 m²/g after calcination in comparison to the neat ceria dehydroxylated at 200° C. (220 m²/g).

### Example 2b

### Preparation of Catalysts Wox/CeO₂

### Step 1: Pretreatment of CeO₂

The pretreatment of the support material was performed in the same way as for the pretreatment of the support in step 1 of Example 1 above.

Preparation of W≡C^{t}(CH₂^{t}Bu)₃ as Precursor

W≡C^{t}(CH₂^{t}Bu)₃ precursors (with *C is ¹³C or ¹²C isotope) were synthesized for preparation of Wox/CeO₂ catalysts for the purpose of tracking the intermediate products (by NMR).

Synthesis of W(≡C^{t}Bu)(CH₂^{t}Bu)₃

The molecular precursor was prepared by modification of the reported synthesis. First, W(Oar)₃ Cl₃ (Ar=2,6-diisopropyl benzyl) was prepared by addition of 2,6-diisopropyl phenol to WCl₆ in toluene. After washing of the excess propofol with pentane, the product is collected in black microcrystalline form. A 1.6 M solution of Mg(CH₂^{t}Bu)Cl in ether (43 ml, 68.8 mmol) was added dropwise to a solution of W(Oar)₃Cl₃ (9.3 g, 11.3 mmol) in 100 ml of ether at 0° C. The ether was removed under vacuum and the remaining solid was extracted three times with 50 ml of pentane. All volatile were then removed under vacuum and the remaining oily product was sublimed at 80° C. and 10⁻⁵ mbar giving 3.2 g (60%) of yellow solid. ¹H NMR (C₆D₆, 300 MHz): δ 1.56 (9 H, s, ≡CC(CH₃)₃), 1.15 (27 H, s, CH₂C(CH₃)₃), 0.97 (6 H, s, CH₂C(CH₃)₃), ²J_{(HW)}=9.7 Hz). ₁₃C{¹H} NMR (C₆D_{6, 75.5} MHz): δ 316.2 (ECC(CH₃)₃, ¹J_{(CW)}=230 Hz), 103.4 (CH₂C(CH₃)₃), ¹J_{(CW)}=90 Hz), 52.8 ((≡CC(CH₃)₃), 34.5 (CH₂ C(CH₃)₃), 34.4 (CH₂C(CH₃)₃), 32.4 (≡CC(CH₃)₃).

Step 2a Grafting precursor ¹³C-labeled [W(E*C t Bu)(*CH₂^{t}Bu)₃] onto ceria

The ¹³C-enriched surface compound was prepared using the same procedure described for the preparation of the non-labeled precursor. Elemental analysis: W 3.2% wt. Solid-state MAS: Unfortunately, due to the presence of paramagnetic Ce (III), the signals are broad and the major peak attributed to the methyl groups of ^{t}Bu fragments is observed ca. 34 ppm. FIG. 20 shows the solid state NMR spectrum of ¹H MAS (left) and ¹³C CP/MAS (right) of the W(≡*C^{t}Bu)(*CH₂^{t}Bu)₃/CeO₂₋₍₂₀₀₎ material. No carbynic carbon (W≡C^{t}Bu) is detected.

Step 2b: Grafting Precursor W(≡C^{t}Bu)(CH₂^{t}Bu)₃ onto CeO₂₋₍₂₀₀₎

A mixture of W(≡C^{t}Bu)(CH₂^{t}Bu)₃ (1.6 g, 1.2 mmol) and CeO₂₋₍₂₀₀₎ (7 9) was stirred in pentane for 4 h. The neopentane released was condensed into a 6 L vessel and quantified by GC. Then, the solid W(≡C^{t}Bu)(CH₂^{t}Bu)₃/CeO₂-200 was washed three times with pentane. The resulting grey powder was dried under vacuum (10⁻⁵ Torr).

The surface organometallic chemistry of ceria grafting of W(≡C^{t}Bu)(CH₂^{t}Bu)₃ onto ceria partially dehydroxylated at 200° C. is shown in FIG. 21, showing grafting of W(≡C^{t}Bu)(CH₂^{t}Bu)₃ on CeO₂₋₂₀₀). The neopentane released was collected and quantified by GC (0.23 mmol neopentane per gram of ceria).

Characterization of W(≡C^{t}Bu)(CH₂^{t}Bu)₃/CeO₂₋₍₂₀₀₎ by DRIFT

The DRIFT spectrum of the resulting material (FIG. 22) shows a partial consumption of the OH group with the concomitant appearance of alkyl groups between 2800 and 3050 cm⁻¹. It is noteworthy that one can observe a small band at 2110 cm⁻¹. FIG. 22 shows the DRIFT spectrum of a) ceria dehydroxylated at 200° C., and b) after grafting of W(≡C^{t}Bu)(CH₂^{t}Bu)₃ (the two insets on the right are zoomed into specific wavenumber range).

Characterization of W(≡C^{t}Bu)(CH₂^{t}Bu)₃/CeO₂₋₍₂₀₀₎ by ICP

The elemental analysis give a tungsten loading of 3.3 wt %, which correspond to 0.18 mmol/g and a carbon weight of 2.16 wt % which gives a C/W ratio of 9.95 corresponding to a bis-grafted species bearing two neopentyl ligands. Furthermore, the qualitative GC analysis of the gas released during the grafting process, revealed the presence of 0.3 mmol of neopentane ca. 1.7 ^{t}BuCH₃ per W. This result is not far from the expected value ca. 2, this discrepancy is due to experimental uncertainties.

Characterization W(≡C^{t}Bu)(CH₂^{t}Bu)₃/CeO₂₋₍₂₀₀₎ by NMR

The ¹H solid state NMR is fairly uninformative due to a broadening/shifting of the signal by paramagnetic species. Although fairly broad, the ¹³C CPMAS spectrum shows the presence of the W—CH₂ and ^{t}Bu fragments (FIG. 23, showing 1H MAS (left) and 13C (right), NMR spectra of W(≡C^{t}Bu)(CH₂^{t}Bu)₃/CeO₂₋₂₀₀)

The sample with 3.3 wt % of W was studied by X-ray absorption spectroscopy (FIG. 24) in order to determine the structure of the supported species. FIG. 24 shows W LIII-edge k3-weighted EXAFS (left) and Fourier transform (right) of solid W(≡C^{t}Bu)(CH₂^{t}Bu)₃/CeO₂₋₍₂₀₀₎ (solid lines are experimental and dashed lines: spherical wave theory).

Characterization W(≡C^{t}Bu)(CH₂^{t}Bu)₃/CeO₂₋₂₀₀ by EXAFT

The parameters extracted from the fit of the EXAFS are in agreement with a (O)₂W(≡C^{t}Bu)(CH₂^{t}Bu) structure, with ca. two oxygen atoms at 1.78(2) Å, attributed to an oxo-ligand and ca. two carbon atoms at 1.78 (2) Å and 2.25 (2) Å, attributed most probably to two neopentyledyne neopentyl ligands respectively. The fit could be also improved by adding a further layer of back-scatters, with only ca. one cerium atom at 3.58(3) Å. The inclusion of tungsten as a second neighbour was not statistically validated. Therefore, this EXAFS study is in agreement with the ((O)₂W(≡C^{t}Bu)(CH₂^{t}Bu)) octahedral structure represented in FIG. 25, showing a proposed structure for W(≡C^{t}Bu)(CH₂^{t}Bu)₃/CeO₂₋₍₂₀₀₎.

### Step 3: Calcination

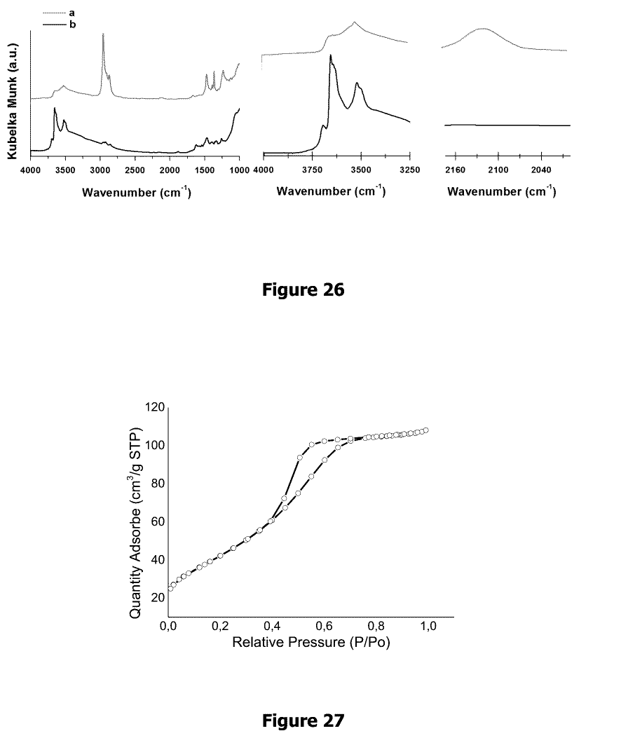

The material [W≡C^{t}Bu)(CH₂^{t}Bu)₃] /CeO₂ was calcined using a glass reactor under a continuous flow of dry air at 500° C. for 16 h. The recovered material prior to catalytic test was characterized. The DRIFT analyses (FIG. 26) showed as expected that the alkyl groups had been burned off. New stretching bands also appeared in the region between 3750 and 3500 cm⁻¹ attributed to (W-OH Ce-OH stretching vibrations). FIG. 26 shows DRIFT spectra of a) ceria dehydroxylated at 200° C., b) after grafting of W(≡C^{t}Bu)(CH₂^{t}Bu)₃, and c) after calcination of W(≡C^{t}Bu)(CH₂^{t}Bu)₃/CeO₂-2oo.

The BET surface area analysis highlighted in FIG. 27 shows a moderate reduction of the surface area to 157 m²/g from the pristine material (258 m²/g). FIG. 27 shows BET Surface Area analysis of W(≡C^{t}Bu)(CH₂^{t}Bu)₃/CeO₂₋₍₂₀₀₎ after calcination WOx/CeO₂₋₂₀₀₎.

### Example 3a

### Preparation of VOx/CeO₂ by Using [V(═O)(OEt)₃]₂ as Precursor

A mixture of a desired amount of [V(═O)(OEt)₃]₂ and CeO₂₋₍₂₀₀₎ (4 g) in toluene (20 ml) was mixed at 25° C. for 4 h. After filtration, the solid [V(═O)(OEt)₃]₂/CeO₂₋₍₂₀₀₎ was washed three times with 10 ml of toluene and 10 ml of pentane. The resulting powder was dried under vacuum (10⁻⁵ Torr).

In the synthesis of {VOx}1-CeO₂₋₍₂₀₀₎, the material [V(═O)(OEt)₃]₂-CeO₂₋₍₂₀₀₎ was calcined using a glass reactor under a continuous flow of dry air at 500° C. for 16 h. The recovered material prior to a catalytic test was characterized by elemental analysis, XPS, RAMAN, DRIFT and UVvis. Different samples were prepared by this procedure: 0.2 to 1.48 wt % V.

### Example 3b

### Preparation of VOx/CeO₂ by using [V(═O)(OⁱPr)₃] as Precursor

A mixture of [V(═O)(OⁱPr)₃] (340 mg, 1.4 mmol) and CeO₂₋₍₂₀₀₎ (4 g) in toluene (20 mL) was mixed at 25° C. for 2 h. After filtration, the solid [V(═O)(OⁱPr)₃]/CeO₂₋₂₀₀ was washed three times with 10 mL of toluene and 10 mL of pentane. The resulting powder was dried under vacuum (10⁻⁵ Torr). ¹H MAS NMR (ppm, 500 MHz): 1.3 (OCH₂CH₃) ¹³C CP MAS NMR (ppm, 200 MHz): δ 76.2 (OCH(CH₃)₂), and 23.8 (OCH(CH₃)₂). Elemental analysis % % V=1.48% wt, % C=1.39 Wt % C/V=4 (th 6).

The material V(═O)(OⁱPr)₃]/CeO₂₋₍₂₀₀₎ was calcined using a glass reactor under a continuous flow of dry air at 500° C. for 16 h. The recovered material prior to a catalytic test was characterized. The DRIFT analyses showed the complete disappearance of CH group of the isopropoxy moieties and the appearance of a new signal around 3690 cm⁻¹ attributed to hydroxyl group (V—OH, and Ce—OH). The surface area measurement of the catalyst indicated a surface of ca. 100 m²/g after calcination.

### Example 4

### Preparation of TaOx/CeO₂ by Using [Ta(OEt)₅]₂ as Precursor

A mixture of [Ta(OEt)₅]₂ (1.425 g, 1.75 mmol) and CeO₂₋₍₂₀₀₎ (2.5 g) in toluene (20 mL) was stirred at 25° C. for 12 h. After filtration, the solid [Ta(OEt)₅]₂/CeO₂₋₂₀₀ was washed three times with 10 mL of toluene and pentane. The resulting yellow powder was dried under vacuum (10⁻⁵ Torr). ¹H MAS NMR (ppm, 500 MHz): δ 4.3 (OCH₂CH₃), 1.1 (OCH₂CH₃)₁₃C CP MAS NMR (ppm, 200 MHz): δ 66.9 (terminal OCH₂CH₃), 64.6 (bridging OCH₂CH₃), 18.6 (terminal OCH₂CH₃), 16.8 (bridging OCH₂CH₃). Elemental analysis % Ta=3.9% wt, % C=2.32% wt, C/Ta=9 (th 8).

The material [Ta(OEt)₅]₂/CeO₂₋₍₂₀₀₎ was calcined using a glass reactor under a continuous flow of dry air at 500° C. for 16 h. The recovered material prior to catalytic test was characterized. The DRIFT analyses showed the complete disappearance of CH group of the ethoxy moieties and the appearance of a new signal around 3690 cm⁻¹ attributed to hydroxyl group (Ta—OH, and Ce—OH). The surface area measurement of the catalyst indicated a surface of ca. 125 m²/g after calcination.

### Example 5

### Preparation of CuOx/CeO₂ by Using [Cu₅(Mes)₅] as Precursor

A mixture of [Cu₅(Mes)₅] (1.6 g, 1.75 mmol) and CeO₂₋₍₂₀₀₎ (2.5 g) was stirred at 25° C. for 12 h (“Mesityl” (Mes) is the 1,3,5-trimethylphenyl (CH₃)₃C₆H₂⁻ group). Then, toluene was added and after filtration, the solid [Cu(Mes)₅]/CeO₂₋₂₀₀ was washed three times with 10 mL of toluene and pentane. The resulting yellow powder was dried under vacuum (10⁻⁵ Torr). ¹H MAS NMR (ppm, 500 MHz): δ 7.0 (Ar), 2.4 (ArMe) ¹³C CP MAS NMR (ppm, 200 MHz): δ 160-126 (Ar), 29 (p-Me), 19 (o-Me). Elemental analysis % Cu=1.89% wt, % C=3.2% wt, C/Cu=9.

The material [Cu₅(Mes)₅]/CeO₂₋₍₂₀₀₎ was calcined using a glass reactor under a continuous flow of dry air at 500° C. for 16 h. The recovered material prior to catalytic test was characterized. The DRIFT analyses showed the complete disappearance of CH group of the mesitylene group. The surface area measurement of the catalyst indicated a surface of ca. 155 m²/g after calcination.

### Example 6

### Preparation of MoOx/CeO₂ by Using Mo(O)₂Mesityl₂ as Precursor

CeO₂ was impregnated with a pentane solution of Mo(O)₂ Mesityl 2. A solution of 450 mg of Mo(O)₂Mesityl₂ (1 mmol) in 20 ml of pentane was added to 4 g mg of CeO₂. The solid was filtrated and washed 3 times with 10 mL pentane to remove the unreacted complex. The DRIFT analyses showed that the bands at higher wavenumbers (v(OH)=3400-3700 cm⁻¹) corresponding to Ce-OH reacted selectively with the molybdenum complex. In addition, bands characteristic of v(C—H) and δ(C—H) in the 2850-3050 and 1110-1470 cm⁻¹ region respectively are found. The green material was calcined using a glass reactor under a continuous flow of dry air at 500° C. for 16 h. The recovered material prior to a catalytic test was characterized. The DRIFT analyses showed the complete disappearance of CH group of the mesityl moieties and the appearance of a new signal around 3690 cm⁻¹ attributed to hydroxyl group. Elemental analysis % Mo=3.05 wt %.

### Example 7

### Preparation of Catalyst NbOx/CeO₂—ZrO₂

Preparation of the support CeO₂—ZrO₂₋₍₂₀₀₎

This new catalyst composition involves the use of ceria doped with other rare-earth or transition metal oxides such as zirconium, which leads to increasing the thermal stability of the support and enhancing low-temperature redox performances.

Ceria-zirconia (with a specific area of 110±6 m² g⁻¹) was calcinated at 500° C. under a flow of dry air. After re-hydratation under inert atmosphere the ceria was partly dehydroxylated at 200° C. under high vacuum (10⁻⁵ Torr) for 15 h to give a yellow solid having a specific surface area of 97±9 m² g⁻¹ (by nitrogen adsorption, FIG. 29) and containing 0.4 mmol OH.g⁻¹ corresponding to 2.4 OH nm⁻². Dehydroxylation of the CeO₂—ZrO₂ was also performed at 200° C. The final DRIFT spectrum shows the presence of different hydroxyl groups on CeO₂—ZrO₂ which is consistent with literature (FIG. 28). Thus, FIG. 28 shows in situ temperature-resolved DRIFT spectra of ceria-zirconia and attribution of different surface (MO—H) stretching vibration, and FIG. 29 shows physisorption isotherms of nitrogen at 77 K of ceria-zirconia after dihydroxylation at 200° C.

Titration of reactive hydroxyl groups on CeO₂—ZrO₂ dehydroxylated at 200° C.

The number of surface OH of the CeO₂—ZrO₂ dehydroxylated at 200° C. was determined by titration with Al(iBu)₃ which is known to be very reactive. The reaction of Al(iBu)₃ with surface OH releases one molecule of isobutene that was quantified by GC. Quantification of surface OH groups with Al(iBu)₃ gives 0.4 mmol OH/g corresponding to 2.4 OH/nm².

The DRIFT spectrum confirmed that all types of the surface OH groups have reacted (FIG. 30). Hence the quantification of surface OH groups with Al(iBu)₃ gives 0.4 mmol OH/g corresponding to 2.4 OH/nm². Thus, FIG. 30 shows the DRIFT spectrum of a) CeO₂—ZrO₂ dehydroxylated at 200° C., and b) after grafting of Al(iBu)₃.

The solid state NMR spectra (FIG. 31) also show the presence of isobutyl groups, but maybe due to the reduction of the support during the grafting, paramagnetism renders the signal broad. Thus, FIG. 31 shows ¹H MAS (left) and ¹³C (right), NMR spectra of Al(iBu)₃/CeO₂—ZrO₂₋₍₂₀₀₎.

Grafting to Obtain [Nb(OEt)₅]₂/CeO₂—ZrO₂₋₍₂₀₀₎

Grafting operations were performed either in glove box or by using a double Schlenk technique. This approach enabled the extraction of the unreacted complex through washing and filtration cycles.

A mixture of a desired amount of [Nb(OEt)₅]₂ and /CeO₂—ZrO₂₋₍₂₀₀₎ (4 g) in toluene (20 ml) was mixed at 25° C. for 4 h. After filtration, the solid [Nb(OEt)₅]₂/CeO₂—ZrO₂₋₍₂₀₀₎ was washed three times with 10 ml of toluene and 10 ml of pentane. The resulting powder was dried under vacuum (10⁻⁵ Torr).

Synthesis of NbOx/CeO₂—ZrO₂₋₍₂₀₀₎

The material [Nb(OEt)_{5]2}/CeO₂—ZrO₂₋₍₂₀₀₎ was calcined using glass reactor under continuous flow of dry air at 500° C. for 16 h. The recovered material prior to a catalytic test was characterized. Different samples were prepared by this procedure in the range of 0.45 to 1.22 wt % Nb.

### Catalytic Activity Test Conditions

Pellet samples of approximate 33 mg were prepared under 1 ton pressure and put into a quartz reactor (diameter 4.5 mm). A mixture of gas consisting of NO 300 ppm, NH₃, 350 ppm, O₂ 10%, H₂O, 3%, CO₂ 10%, He (balance), was sent through a catalytic bed at the rate of 300 mL/min. The reactor was heated from room temperature to 600° C. with a heating rate of 10° C./ min. The system was kept at 600° C. for 10 min before cooling down to room temperature. Gas composition at the outlet was monitored during the heating up and cooling down by a combination of FTIR, MS and chemiluminiscence.

1. A method comprising using a catalyst material as an ammonia selective catalytic reduction (NH₃-SCR) catalyst for nitrogen oxides (NOx) reduction, wherein said catalyst material being prepared by a process comprising the steps of:
(a) providing a support material having surface hydroxyl (OH) groups, wherein the support material is ceria (CeO₂), zirconia (ZrO₂) or a combination thereof, and wherein the support material contains at least 0.3 mmol and at most 2.0 mmol OH groups/g of the support material;
(b) reacting the support material having surface hydroxyl (OH) groups of step (a) with at least one of the following:
(b1) a compound containing at least one alkoxy or phenoxy group bound though its oxygen atom to a metal element from Group 5 (V, Nb, Ta) or Group 6 (Cr, Mo, W);
(b2) a compound containing at least one hydrocarbon group bound though a carbon atom to a metal element from Group 5 (V, Nb, Ta) or Group 6 (Cr, Mo, W);
(b3) a compound containing at least one hydrocarbon group bound though a carbon atom to a metal element which is copper (Cu); and
(c) calcining the product obtained in step (b) in order to provide a catalyst material in which a metal element from Group 5 or Group 6, or Cu, is present as an oxide on the support material.

2. The method according to claim 1, wherein the support material is a ceria (CeO₂) or ceria-zirconia (CeO₂—ZrO₂) support.

3. The method according to claim 1, wherein the support material contains at least 0.5 mmol and at most 1.3 mmol OH groups/g of the support material.

4. The method according to claim 1, wherein the compound containing at least one alkoxy or phenoxy group bound though its oxygen atom to a metal element from Group 5 (V, Nb, Ta) or Group 6 (Cr, Mo, W) is at least one compound selected from the group consisting of: [Nb(OEt)₅]₂; Nb(OAr)₅ where Ar is the 1,3,5-trimethylphenyl (CH₃)₃C₆H₂— group; [W=O(OEt)₄]₂; [V(═O)(OEt)₃]₂; [V(═O)(OⁱPr)₃]; and [Ta(OEt)₅]₂.

5. The method according to claim 1, wherein the compound containing at least one hydrocarbon group bound though a carbon atom to a metal element from Group 5 (V, Nb, Ta) or Group 6 (Cr, Mo, W) is at least one compound selected from the group consisting of: W≡C^{t}Bu(CH₂^{t}Bu)₃; and Mo(O)₂Mesityl₂.

6. The method according to claim 1, wherein the compound containing at least one hydrocarbon group bound though a carbon atom to a metal element which is copper (Cu) is [Cu₅(Mes)₅].

7. The method according to claim 1, wherein the temperature in calcining step (c) is at least 300° C., the duration of the calcining step being least 1 hour.

8. The method according to claim 1, wherein the temperature in calcining step (c) is at most 700° C., and/or the duration of the calcining step is at most 30 hours.

9. The method according to claim 1, wherein the compound obtained in step (b1) or (b2) has at least 0.1 wt % and at most 5.0 wt % of metal element from Group 5 (V, Nb, Ta) or Group 6 (Cr, Mo, W) or Cu, in elemental analysis of the compound obtained in step (b1) or (b2).

10. The method according to claim 1, wherein the compound obtained after calcining step (c) has at least 0.1 wt % and at most 5.0 wt % of metal element from Group 5 (V, Nb, Ta) or Group 6 (Cr, Mo, W) or Cu, in elemental analysis of the compound obtained after calcining step (c).

11. The method according to claim 1, comprising contacting the catalyst material with an exhaust gas stream comprising NOx gases, the catalyst material converting NOx gases in the exhaust gas stream to N₂.
